(19) United States
(12) Patent Application Publication
(10) Pub. No.: US 2015/0103680 A1
(43) Pub. Date: Apr. 16, 2015

(54) DYNAMIC SCHEDULING FOR MULTI-CHANNEL CONCURRENCY SWITCHING

(71) Applicant: QUALCOMM Incorporated, San Diego, CA (US)

(72) Inventors: Kumar Anand, Santa Clara, CA (US); Steven J. Kuhn, Santa Clara, CA (US); Alireza Raissinia, Monte Sereno, CA (US)

(73) Assignee: QUALCOMM Incorporated, San Diego, CA (US)

(21) Appl. No.: 14/172,824

(22) Filed: Feb. 4, 2014

Related U.S. Application Data
(60) Provisional application No. 61/890,113, filed on Oct. 11, 2013.

(51) Int. Cl. H04W 28/02; H04W 72/10; H04L 12/26; H04W 72/04; H04W 24/08

(52) U.S. Cl. CPC H04W 28/0236; H04W 72/0446; H04W 24/08; H04L 43/0882; H04W 28/0252; H04W 72/10; H04L 43/0858
USPC 370/252; 370/336

(57) ABSTRACT

Described embodiments are directed to systems, methods, and apparatuses for dynamically scheduling channel dwell times across two or more channels across a single radio using Multi-Channel Concurrency. Communications may be transmitted and/or received over a first channel of the radio during a first dwell time of a dwell period and over a second channel of the radio during a second dwell time of the dwell period. Some embodiments include adjusting the dwell period and/or dwell time spent actively transmitting or receiving on two or more channels based on measured channel utilization metrics, to drive toward a balanced utilization across the two or more channels. Other embodiments include adjusting the dwell period and/or dwell time of multiple channels based on latency information and/or priority information of at least one of the channels.

### CROSS REFERENCE

The present application for patent claims priority benefit of co-pending U.S. Provisional Patent Application No. 61/890,113, entitled “DYNAMIC SCHEDULING FOR MULTI-CHANNEL CONCURRENCY SWITCHING”, by Anand et al., filed Oct. 11, 2013, assigned to the assignee hereof, and expressly incorporated by reference herein.

### BACKGROUND

The following relates generally to communications, and more specifically to scheduling data communications on two or more channels utilized by a single radio. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Wireless Local Area Networks (WLANs), such as Wi-Fi (IEEE 802.11) networks are widely deployed and used. A particular implementation of Wi-Fi, Wi-Fi Direct also known as P2P, is a standard that enables devices to connect easily with each other at Wi-Fi data transfer rates without requiring a dedicated Wi-Fi access point (hard AP). In this technique, a Wi-Fi-Direct enabled device (e.g., a P2P device) can be elected to operate as a soft-AP or Group Owner (GO) for communications with other Wi-Fi devices. In some implementations, the P2P GO can also be used in conjunction with one or more APs to effectively extend the AP(s)'s coverage, adapt to different communication path conditions, and increase throughput of the system.

Some Wi-Fi enabled devices, such as smart phones, tablets, laptops, printers, TVs, other displays, etc., can employ Multi-Channel Concurrency (MCC) to allow a single Wi-Fi radio of a device to support concurrent operation on two or more channels, for instance on the same or different frequency bands, such as a 2.4 GHz and/or a 5 GHz band. This is accomplished by time sharing the Wi-Fi radio, switching between channels with a given period and duty cycle, and may be utilized in both Wi-Fi and Wi-Fi-Direct communication links. During an MCC mode of operation, a multi-channel scheduler controls the channel switching frequency and time allocated to each channel (or channel dwell time). Existing multi-channel scheduling techniques employ static scheduling using pre-determined channel dwell times, which may not reflect the impact of various factors such as channel traffic or channel conditions. Accordingly, there is a need for improved methods for MCC operation.

### SUMMARY

Described embodiments are directed to systems, methods, and apparatuses for dynamically scheduling channel time allocations across two or more channels utilized by a single radio. By scheduling the time allocations between two or more channels based on channel and/or traffic conditions, overall performance of the radio/system can be increased. Some embodiments include adjusting the duty cycle and/or period of time, also referred to herein as the dwell time, spent actively transmitting or receiving on two channels based on measured channel utilization metrics in real time. The dwell times may be adjusted to drive toward a balanced utilization across the two channels. Other embodiments include adjusting the duty cycle and/or dwell time of two channels based on latency information and/or priority information of at least one of the channels. Yet other embodiments may combine these two techniques to adjust the duty cycle and/or dwell time of two channels based on channel utilization metrics and latency and/or priority information of at least one of the channels to better manage and utilize the characteristics of each channel and improve data flow, throughput, etc. These techniques may also be applied to any number of channels to increase channel load, utilization, etc., across the multiple channels in a similar fashion, as will be further described below.

Some embodiments include methods for dynamically scheduling channel dwell times in a wireless communications network. These methods can include using information regarding communications over a first channel during a first dwell time of a dwell period and over a second channel during a second dwell time of the dwell period to determine channel utilization metrics for the first channel and the second channel, and adapting at least one of the first dwell time and the second dwell time based on the determined channel utilization metrics.

In some embodiments, communicating over the first and second channels is performed by a single transceiver, where the first channel and the second channel are in different Wi-Fi bands. The first channel can include a Wi-Fi communication link with an access point (AP), and the second channel can include a Wi-Fi-Direct communication link.

In some embodiments, adapting at least one of the first dwell time and the second dwell time includes balancing channel utilization across the first channel and the second channel based at least in part on a comparison of the determined channel utilization metrics for the first and second channels. In some instances, the channel utilization metrics for the first and second channels are based at least in part on ratios of transmitted and received traffic in sample time periods divided by channel capacities for the first and second channels. The channel capacities of the first and second channels can further be based at least in part on at least one of the group consisting of a physical link speed of the respective channel, a proportion of time the respective channel is available to transmit, a medium access control (MAC) layer protocol efficiency of the respective channel, a transport layer protocol efficiency of the respective channel, and any combination thereof. In some cases, the channel utilization metrics for the first and second channels are based at least in part on an aggregate of calculated utilization metrics over multiple sample time periods.

Methods for dynamically scheduling channel dwell times in a wireless communications network can also include adjusting the first dwell time and the second dwell time to first and second default dwell times responsive to a reset condition. The reset condition can include a change in the channel utilization metrics for the first or second channels over a sample period being greater than a predetermined change threshold. The reset condition can also include a noise level on the first or second channels exceeding a predetermined noise threshold, a change in noise level for the first or second channels exceeding a predetermined noise change threshold, the channel utilization metrics for the first or second channels exceeding a first predetermined threshold, and/or the channel utilization metrics for the first and second channels being less than a second predetermined threshold. In some cases the first default dwell time is equal to the second default dwell time.

In some embodiments, adapting at least one of the first dwell time or the second dwell time can include adjusting at least one of the first dwell time and the second dwell time an amount proportionate to a determined difference between the channel utilization metrics for the first channel and the second channel.

In some cases, the first dwell time and the second dwell time are prevented from being adjusted above a predetermined maximum dwell time. The predetermined maximum dwell time for the first and second channels can be based at least in part on a ratio between the first dwell time and the second dwell time. s

Some embodiments include an apparatus for dynamically scheduling channel dwell times in a wireless communications network. The apparatus can include a channel utilization manager to determine channel utilization metrics for a first channel and a second channel using information regarding communications over the first channel during a first dwell time of a dwell period and over the second channel during a second dwell time of the dwell period. The apparatus may also include a dwell time adaptor to adapt at least one of the first dwell time and the second dwell time based on the determined channel utilization metrics.

In some instances, channel utilization manager may also be configured to balance channel utilization across the first channel and the second channel based at least in part on a comparison of the determined channel utilization metrics for the first and second channels. The channel utilization metrics for the first and second channels can be based at least in part on ratios of transmitted and received traffic in sample time periods divided by channel capacities for the first and second channels. In some cases, the channel capacities of the first and second channels may further be based at least in part on at least one from the group consisting of a physical link speed of the respective channel, a proportion of time the respective channel is available to transmit, a medium access control (MAC) layer protocol efficiency of the respective channel, a transport layer protocol efficiency of the respective channel, and a combination thereof.

Some embodiments include an apparatus for dynamically scheduling channel dwell times in a wireless communications network. The apparatus may include means for using information regarding communications over a first channel during a first dwell time of a dwell period and over a second channel during a second dwell time of the dwell period to determine channel utilization metrics for the first channel and the second channel. The apparatus may further include means for adapting at least one of the first dwell time and the second dwell time based at least in part on the determined channel utilization metrics. The means for adapting can further be configured to balance channel utilization across the first channel and the second channel based at least in part on a comparison of the determined channel utilization metrics for the first and second channels.

In some instances, the channel utilization metrics for the first and second channels are based at least in part on ratios of transmitted and received traffic in sample time periods divided by channel capacities for the first and second channels. In some cases, the channel capacities of the first and second channels may be further based at least in part on at least one from the group consisting of a physical link speed of the respective channel, a proportion of time the respective channel is available to transmit, a medium access control (MAC) layer protocol efficiency of the respective channel, a transport layer protocol efficiency of the respective channel, and any combination thereof. In some embodiments, the channel utilization metrics for the first and second channels may additionally or alternatively be based at least in part on an aggregate of calculated utilization metrics over multiple sample time periods.

In some embodiments, the apparatus may also include means for adjusting the first dwell time and the second dwell time to a first and a second default dwell time responsive to a reset condition, the reset condition comprising at least one from the group consisting of a change in the channel utilization metrics for the first or second channels over a sample period being greater than a predetermined change threshold, a noise level on the first or second channels exceeding a predetermined noise threshold, a change in noise level for the first or second channels exceeding a predetermined noise change threshold, the channel utilization metrics for the first or second channels exceeding a first predetermined threshold, and the channel utilization metrics for the first and second channels being less than a second predetermined threshold.

In some embodiments, the means for adapting at least one of the first dwell time and the second dwell time may be further configured to adjust at least one of the first dwell time and the second dwell time an amount proportionate to a determined difference between the channel utilization metrics for the first channel and the second channel.

Some embodiments include a method, the method including obtaining at least one of a latency information and a priority information for at least one of a first channel and a second channel, and adapting, using information regarding communications over the first channel during a first dwell time of a dwell period and over the second channel during a second dwell time of the dwell period, at least one of the first dwell time and the second dwell time based at least in part on at least one of the obtained latency information and the obtained priority information.

Some embodiments also include determining channel utilization metrics for the first channel and the second channel, and adapting at least one of the first dwell time or the second dwell time further based t least in part on the determined channel utilization metrics. Adapting at least one of the first dwell time or the second dwell time may include setting at least one of an upper dwell time limit and a lower dwell time limit for at least one of the first channel and the second channel based at least in part on at least one of the obtained latency information and the obtained priority information.

In some embodiments, the priority information may include at least one of a first priority comprising a maximum delay value and a second priority comprising a minimum throughput value. At least one of the obtained latency information and the obtained priority information can relate to a traffic type of a traffic session associated with at least one of the first channel or the second channel.

Some embodiments include an apparatus for dynamically scheduling channel dwell times in a wireless communications network. The apparatus can include a latency priority information manager to obtain at least one of a latency information and a priority information for at least one of a first channel and a second channel. The apparatus may also include a dwell time adaptor configured to adapt, using information regarding communications over the first channel during a first dwell time of a dwell period and over the second channel during a second dwell time of the dwell period, at least one of the first dwell time and the second dwell time based at least in part on at least one of the obtained latency information and the obtained priority information. The dwell time adaptor may also be configured to set at least one of an upper dwell time limit and a lower dwell time limit for at least one of the first channel and the second channel based at least in part on at least one of the obtained latency information and the obtained priority information.

In some embodiments, the apparatus may also include a channel utilization manager configured to determine channel utilization metrics for the first channel and the second channel, and the adapting at least one of the first dwell time and the second dwell time may be based at least in part on the determined channel utilization metrics.

In some cases, the priority information may include at least one of a first priority including a maximum delay value and a second priority including a minimum throughput value. At least one of the obtained latency information and the obtained priority information may relate to a traffic type of a traffic session associated with at least one of the first channel and the second channel.

Some embodiments include another apparatus for dynamically scheduling channel dwell times in a wireless communications network. The apparatus may include means for obtaining at least one of a latency information and a priority information for at least one of a first channel and a second channel. The apparatus may further include means for adapting, using information regarding communications over the first channel during a first dwell time of a dwell period and over the second channel during a second dwell time of the dwell period, at least one of the first dwell time and the second dwell time based at least in part on at least one of the obtained latency information and the obtained priority information. In some embodiments, the apparatus may also include means for determining channel utilization metrics for the first channel and the second channel, whereby adapting at least one of the first dwell time and the second dwell time may be based at least in part on the determined channel utilization metric.

The means for adapting can further be configured to set at least one of an upper dwell time limit and a lower dwell time limit for at least one of the first channel and the second channel based at least in part on at least one of the obtained latency information and the obtained priority information.

Some embodiment include a computer program product including a non-transitory computer-readable medium storing instructions executable by a processor to determine channel utilization metrics for a first channel and a second channel. The instructions may also be executable by the processor to obtain at least one of a latency information and a priority information for at least one of the first channel and the second channel using information regarding communications over the first channel during a first dwell time of a dwell period and over the second channel during a second dwell time of the dwell period, and adapt at least one of the first dwell time and the second dwell time based at least in part on the determined channel utilization metrics and the obtained at least one of the latency information and the priority information.

In some embodiments, the instructions executable by the processor to adapt at least one of the first dwell time and the second dwell time may further include instructions to balance channel utilization across the first channel and the second channel based at least in part on a comparison of the determined channel utilization metrics for the first and second channels. In yet some embodiments, the instructions executable by the processor to adapt at least one of the first dwell time and the second dwell time further include instructions to set at least one of an upper dwell time limit and a lower dwell time limit for at least one of the first channel and the second channel based at least in part on at least one of the obtained latency information and the obtained priority information.

In some embodiments, the channel utilization metrics for the first and second channels are based at least in part on ratios of transmitted and received traffic in sample time periods divided by channel capacities for the first and second channels. The channel capacities of the first and second channels may be based at least in part on at least one from the group consisting of a physical link speed of the respective channel, a proportion of time the respective channel is available to transmit, a medium access control (MAC) layer protocol efficiency of the respective channel, a transport layer protocol efficiency of the respective channel, and a combination thereof.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a system for dynamic scheduling of channel dwell times across two or more channels in accordance with various embodiments;

FIG. 2 shows another diagram of a system for dynamic scheduling of channel dwell times across two or more channels in accordance with various embodiments;

FIG. 3A shows a timing diagram illustrating channel dwell times and channel utilizations of two channels in accordance with various embodiments;

FIG. 3B shows another timing diagram illustrating channel dwell times and channel utilizations of two channels in accordance with various embodiments;

FIG. 4 shows a flow block diagram illustrating an embodiment of a method for dynamic scheduling of channel dwell times across two or more channels in accordance with various embodiments;

FIG. 5A shows a block diagram illustrating a device for dynamic scheduling of channel dwell times across two or more channels in accordance with various embodiments;

FIG. 5B shows a block diagram illustrating another device for dynamic scheduling of channel dwell times across two or more channels in accordance with various embodiments;

FIG. 5C shows a block diagram illustrating another device for dynamic scheduling of channel dwell times across two or more channels in accordance with various embodiments;

FIG. 6 shows a block diagram illustrating another device for dynamic scheduling of channel dwell times across two or more channels in accordance with various embodiments; and

FIGS. 7-10 illustrate flowcharts of methods for dynamic scheduling of channel dwell times across two or more channels in accordance with various embodiments.

### DETAILED DESCRIPTION

Described embodiments are directed to systems, methods, and apparatuses for dynamically scheduling channel time allocations across two or more channels utilized by a single radio. By scheduling the time allocations between two or more channels based on channel and/or traffic conditions, overall performance of the radio/system can be increased. Some embodiments include adjusting the duty cycle and/or period of time, also referred to herein as the dwell time, spent actively transmitting or receiving on two channels based on measured channel utilization metrics in real time. The dwell times may be adjusted to drive toward a balanced utilization across the two channels. Other embodiments include adjusting the duty cycle and/or dwell time of two channels based on latency information and/or priority information of at least one of the channels. Yet other embodiments may combine these two techniques to adjust the duty cycle and/or dwell time of two channels based on channel utilization metrics and latency and/or priority information of at least one of the channels to better manage and utilize the characteristics of each channel and improve data flow, throughput, etc. These techniques may also be applied to any number of channels to increase channel load, utilization, etc., across the multiple channels in a similar fashion, as will be further described below.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

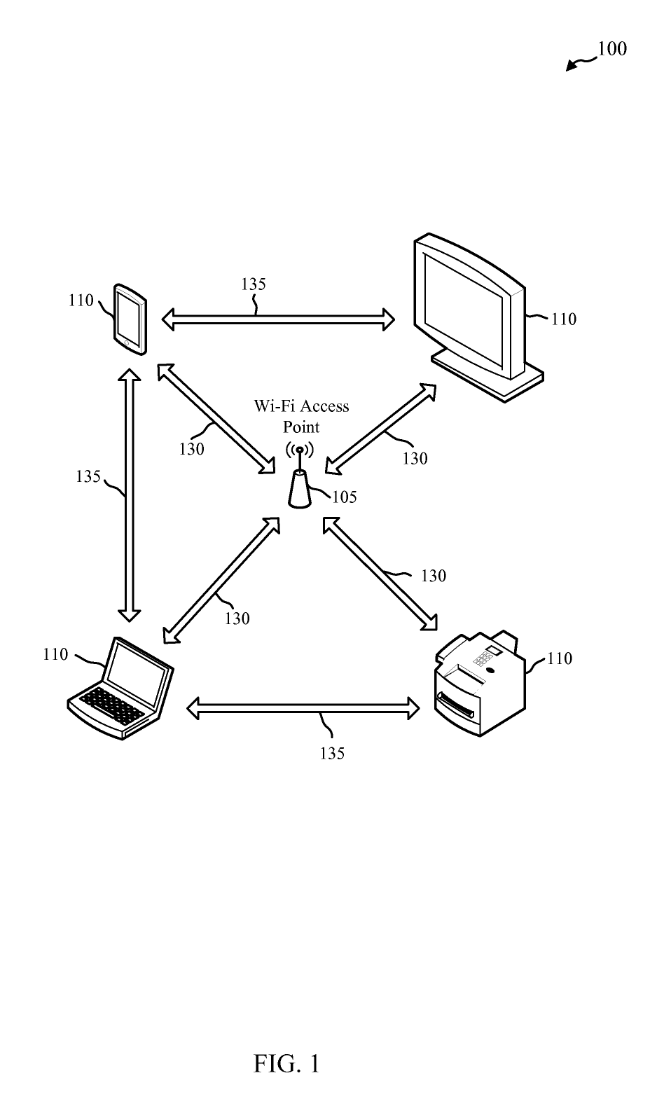

Referring first to FIG. 1, a block diagram illustrates an example of a WLAN or Wi-Fi network 100 such as, e.g., a network implementing at least one of the IEEE 802.11 family of standards. The network 100 may include an access point (AP) 105 and one or more wireless devices 110, such as mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the network 100 may include multiple APs 105. Each of the wireless devices 110, also referred to as wireless stations, stations (STAs), mobile stations (MSs), mobile devices, access terminals (ATs), user equipments (UEs), subscriber stations (SSs), or subscriber units may associate and communicate with an AP 105 via a communication link 130. Each AP 105 has a coverage area (not shown) such that stations 110 within that area can typically communicate with the AP 105. The devices 110 may be dispersed throughout the coverage area. Each device 110 may be stationary or mobile.

Although not shown in FIG. 1, a station 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) (not shown) is used to connect APs in an extended service set. A coverage area for an access point 105 may be divided into sectors making up only a portion of the coverage area (not shown). The system 100 may include access points 105 of different types (e.g., metropolitan area, home network, etc.), with varying sizes of coverage areas and overlapping coverage areas for different technologies. Although not shown, other wireless devices can communicate with the AP 105.

While the devices 110 may communicate with each other through the AP 105 using AP links 130, each device 110 may also communicate directly with one or more other devices 110 via direct wireless links 135. Examples of direct wireless links 135 may include Wi-Fi Direct connections and connections established by using a Wi-Fi Tunneled Direct Link Setup (TDLS) link. The devices 110 and AP 105 in these examples may communicate according to the WLAN radio and baseband protocols including by implementing the physical and MAC layers from IEEE 802.11, and its various versions including, but not limited to, 802-11b, 802.11g, 802.11a, 802.11n, 802.11ac, 802.1 lad, 802.11ah, etc. In other implementations, other peer-to-peer connections and/or ad hoc networks may be implemented in system 100.

In one embodiment, a device 110 may be connected to a another device 110 via a Wi-Fi Display connection. Wi-Fi Display, which may be known as Miracast, allows one device 110, such as a portable device or computer, to transmit video and audio to a compatible display, such as another device 110, wirelessly. It enables delivery of compressed standard or high-definition video over a direct wireless link (e.g., peer-to-peer link 135), or an indirect wireless link (e.g., via AP links 130).

Miracast allows users to echo the display from a first device 110 onto the display of another device 110 by video and/or audio content streaming. In some implementations, the link 135 between the two devices 110 may be bi-directional. In one configuration, the connection between the two devices 110 may also allow users to launch applications stored on a first device 110 via a second device 110. For example, the second device 110 may include various input controls (e.g., mouse, keyboard, knobs, keys, user interface buttons). These controls may be used at the second device 110 to initialize and interact with applications stored on the first device 110.

In some instances, devices 110 can employ Multi-Channel Concurrency (MCC) to allow a single Wi-Fi radio of a device 110 to support concurrent operation on two or more channels or links 130, 135. MCC may be used to support multiple concurrent channels on the same or different frequency bands, such as on the 2.4 GHz and/or 5 GHz bands. This can be accomplished by time sharing the Wi-Fi radio, switching between channels with a given period and duty cycle, and may be utilized in Wi-Fi, Wi-Fi-Direct, Wi-Fi Display, or other WLAN communication links. During an MCC mode of operation, a Multi-Channel scheduler, or other similar program, subroutine, control mechanism, etc., can control the channel switching frequency and time allocated to each channel (dwell time).

Accordingly, a first wireless device 110, for example, may communicate concurrently via one radio using MCC with both the AP 105 and a second wireless device 110 via links 130 and 135 respectively. In some instances, the AP 105 may communicate a data stream to the first device 110 via link 130, which can then communicate that data stream (e.g., with or without re-encoding, etc.) to the second device 110 via link 135. In other instances a first data stream may be transmitted via link 130 from the AP 105 to a first device 110, and a second data stream may be transmitted via link 135 between the first device 110 and a second device 110 concurrently. The first device may employ MCC to communicate concurrently over both links utilizing a single radio. In one example, links 130 may use a first band (e.g., 2.4 GHz channels), while links 135 may use a different band (e.g., 5 GHz channels) due to different configurations of the wireless clients 110, different path conditions, different distances of the links, etc.

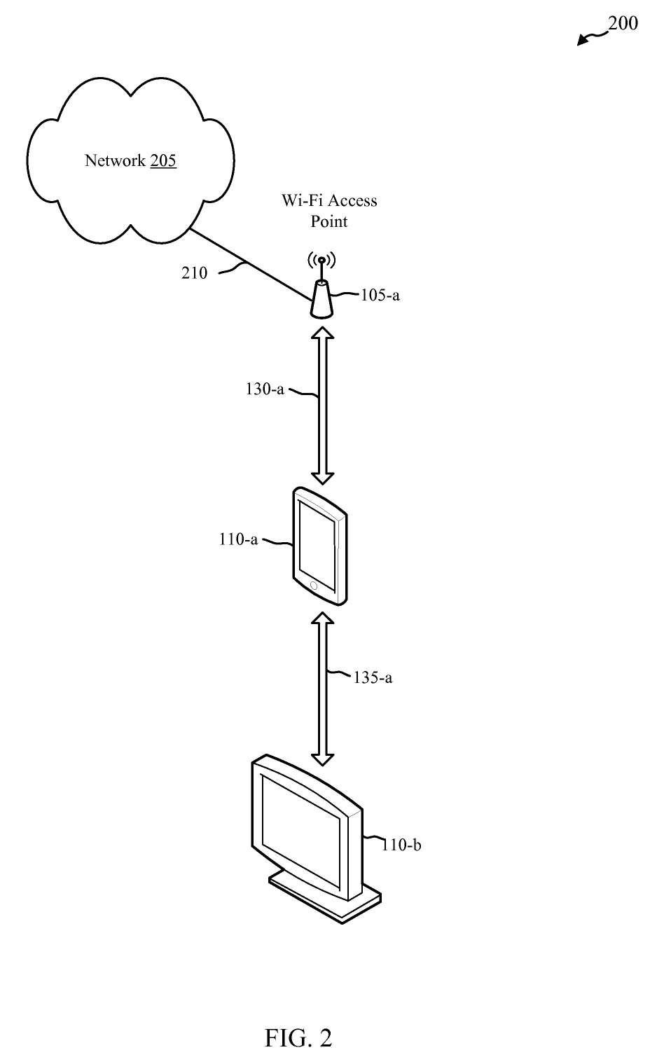

Referring now to FIG. 2, a system 200 includes a network 205 in communication with an AP 105-a via a communication link 210, which may be wireless or wired. System 200 may be an example of or a portion of system 100. The AP 105-a may communicate with a primary device 110-a, which may be a mobile device, via link 130-a, for example implementing a WLAN technology, such as Wi-Fi. The mobile device 110-a may further communicate with another device 110-b, which may be a display device, via link 135-a, which in some cases may be a Wi-Fi-Direct or Wi-Fi Display link. Both links 130-a and 135-a may be implemented using a single radio of the mobile device 110-a. The mobile device 110-a may support concurrent communications over the two links 130-a and 135-a by switching the time the single radio of the mobile device 110-a spends transmitting and receiving on each link 130-a, 135-a. The links 130-a and 135-a may be established using different frequencies, such that the single radio of device 110-a may tune to different frequencies during the respective dwell times across the links 130-a, 135-a. In some instances, the link requirements of link 130-a and 135-a may vary, such that equal dwell times across links 130-a and 135-a for a single radio of mobile device 110-a may not provide optimal throughput or performance for link 130-a or 135-a. The mobile device 110-a may utilize MCC scheduling to allocate time between links 130-a and 135-a, for example to accommodate different channel conditions between links 130-a and 135-a, different data and/or different data requirements across the links 130-a, 135-a, changing conditions over one or more of the links 130-a, 135-a, etc. While the ensuing description describes MCC in the context of a mobile device 110 communicating over an access point link 130 and a direct link 135 concurrently, the described techniques may be applied to any combination of direct or indirect links including concurrent connections of a mobile device 110 with multiple APs 105.

The components of systems 100 and/or 200 such as the mobile devices 110 may be configured to dynamically adapt the channel dwell times of single radio supporting two or more channels concurrently based on various factors related to traffic and/or channel conditions. In some embodiments, an MCC scheduler adapts dwell times based on measured channel utilization of the supported channels. For example, the MCC scheduler may adjust the dwell times to balance channel utilization across two or more channels. Additionally or alternatively, the channel dwell times may be adapted based on latency information and/or priority information of at least one of the channels. In some embodiments, dwell times may be dynamically adjusted based on channel utilization and latency and/or priority information. Dynamic adaptation of dwell times may include determining conditions indicating that channel dwell times should be reset to a default state. For example, the MCC scheduler may reset channel dwell times to a default state upon detection of channel saturation, idle conditions, large transient conditions, or non-convergence of channel utilization.

Adapting dwell times based on channel utilization may provide better time allocation and ability to adapt to changing traffic conditions by accounting for data traffic and channel capacity. In some cases, adaptation of channel dwell times based on channel utilization may take different factors into account. As an example, it may be beneficial to adjust channel dwell times based on channel bandwidth capacities, and more particularly based on differences in channel bandwidth capacities. For instance, a channel with higher capacity or bandwidth may be allocated proportionally less dwell time than a channel with less capacity or bandwidth, to allow the device to communicate more effectively over the lower bandwidth channel without disrupting traffic flow over the higher bandwidth channel. Additionally or alternatively, channel dwell times can be adapted based on a channel interference (e.g., noise, etc.) factor of one or more of the channels. For example, a noisier channel may have lower channel capacity while having a higher utilization, such that it may be beneficial to allocate more time to the noisier channel. Channel dwell times may further be adapted based on link or channel quality. For example, a channel with poor link quality may have a lower channel capacity. In this case, it may be beneficial to allocate more dwell time to the channel with less channel quality. Adaptation of channel dwell times may also take into account traffic considerations. For example, an idle link may have a much lower utilization than an active link allowing the active link to borrow dwell time from the inactive link.

Another approach to achieve a more optimum channel time allocation between two channels can include adjusting channel time allocation of two or more channels based on latency or priority information of at least one of the channels. For example, various types of links or data traffic may have operational latency bounds. These bounds may include data requirements over one or more of the links, such as a maximum latency for voice over IP (VoIP), two-way video communications, and the like. In MCC scheduling, latency may be defined as a limit on the delay a channel experiences based on time spent on another channel. In addition, a specified link may have a minimum operational throughput. These considerations, and others, may be prioritized based on the needs of the channels. In one instance, latency may be ranked a higher priority than minimum throughput. Other metrics may be used to represent priority of a channel, such as in relation to an objective value independent of other channels, such as throughput, or a metric that is dependent on other channels.

In some embodiments, channel utilization may be defined as the ratio of measured transmit (TX) and received (RX) traffic per unit time; divided by the theoretical user datagram protocol (UDP) throughput of the link. The theoretical throughput (or channel capacity) can be determined by factoring in the physical (PHY) link speed (e.g., TX/RX rate), the proportion of time the channel is available for transmission and reception, determined by, for example, monitoring the clear channel assessment (CCA) noise level, and/or the medium access control (MAC) and transport protocol efficiencies. Channel utilization for a single channel, in some embodiments, may be represented by:

$$Channel Utilization = \frac{( TX Bytes + RX Bytes ) / ( Sample Time )}{( Avg PHY Rate ) ( 1 - k ) ( 1 - Noise )}$$

where
TX Bytes=Total TX Bytes Transmitted on a channel in a Sample Time;
RX Bytes=Total RX Bytes Received on a channel in a Sample Time;
Average PHY Rate=Average TX PHY rate of the channel;
K=Correction Factor to account for MAC overhead (Typically ˜30%); and
Noise=Noise (Interference) %.

The TX and RX statistics on each channel may be sampled/measured, for example, at channel entry and channel exit points. The delta between the entry and exit points can be defined as a sample ‘X’. ‘N’ such samples can be aggregated and averaged to derive an average channel utilization. N may be any value, determined by, for example, how quickly it is desired that channel time allocations can adapt to changing channel conditions or channel loads, etc. N may also be selected based on how quickly data communicated across one or more channels is predicted to change, etc. Based on the average channel utilization, dwell times across the monitored channels may be adapted to, for example better balance the channel utilization across the multiple channels to increase performance of the radio, system, etc. The other parameters including average PHY Rate, K, and/or Noise may be sampled at any desired interval, or may be preset at channel initialization, for example.

As the channel utilization of one of the channels increases, that channel can be given a greater amount of time or greater proportion of time to be active, such that the channel utilization of that channel will decrease. When the utilization percentage of both channels converges to a predetermined channel utilization ratio (e.g., balanced, etc.), the current time proportions can be maintained. Note that the channel utilization metric(s) for dynamic scheduling is not limited to two channels and can be applied to three or more channels as well. For the sake of explanation, the two channels scenario is primarily described; however, it should be appreciated that the techniques described can be applied to a three or more channel scenario to achieve similar advantages.

One implementation of the described techniques includes a dynamic scheduler algorithm, which by default, can initiate both channels with a 50/50 distribution of dwell time. However any other initial channel time allocations, or default dwell times, can be used, such as 20/80 or 30/70 on two channels. If more than two channels are active, any allocation may be used, such as 30/30/40. Irrespective of the number of channels and the starting division point, the algorithm can eventually converge towards a dwell percentage distribution that gives a predetermined dwell time ratio (e.g., balanced channel utilization). The predetermined dwell time ratio may depend, for example, on other channel constraints (e.g., requested throughput, etc.). In some cases, the steps or increments to adjust the dwell percentage are larger when the utilization imbalance is larger and smaller as the utilizations approach equal values or some other type of target or predetermined dwell time ratio.

In some embodiments, it may be useful to adjust channel dwell times based on channel utilizations, further modified by latency and/or priority information of one or more of the channels. Channel priority and latency may be determined using characteristics of data traffic (e.g., traffic type, etc.) carried over the first and second channels. In some embodiments, channel priority may be used to inform the channel utilization ratio to which the adaptation converges. In other words, balancing channel utilization using the present techniques may converge to some ratio other than equal channel utilization for each channel. For example, a first channel may be primarily or exclusively used for VoIP or two way video communications that may have minimum throughput requirements. Based on the priority of the traffic, the first channel may be given a higher channel utilization than the second channel in the channel utilization ratio. Additionally or alternatively, channel priority and minimum throughput requirements may equate to the first channel requiring a minimum dwell time.

In some embodiments, latency information of one or more channels may similarly modify balancing of channel utilizations. For example, a maximum latency required by a first channel may set a maximum dwell time on a second channel. Additionally or alternatively, latency may be used to inform the channel utilization ratio to which the adaptation converges as discussed above.

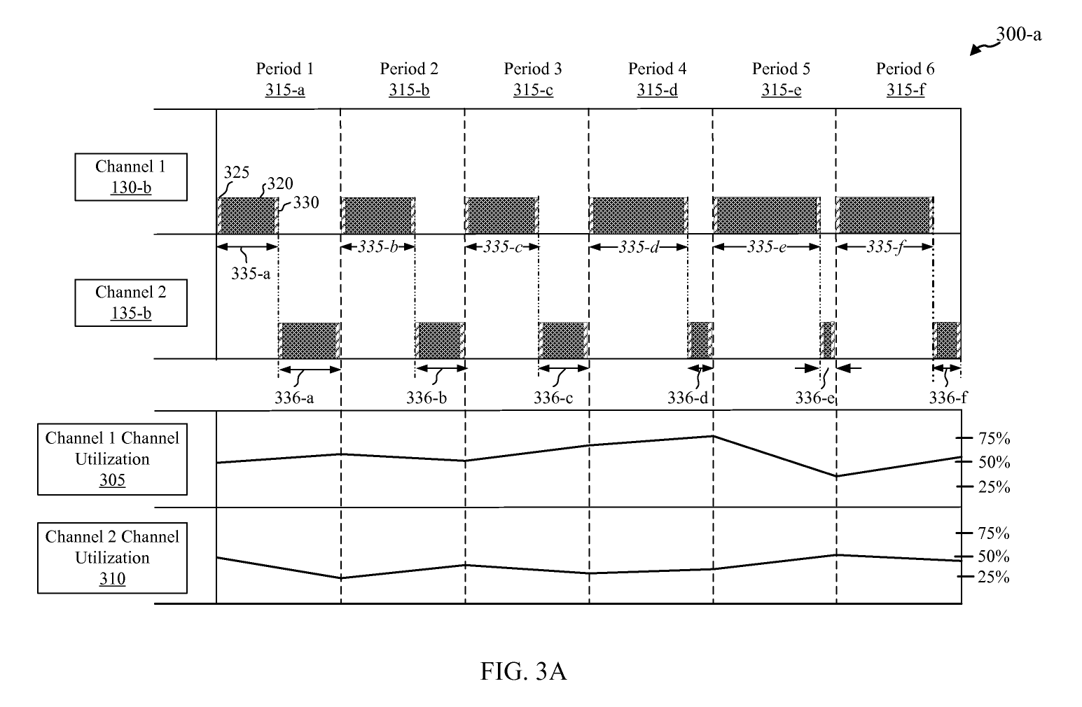

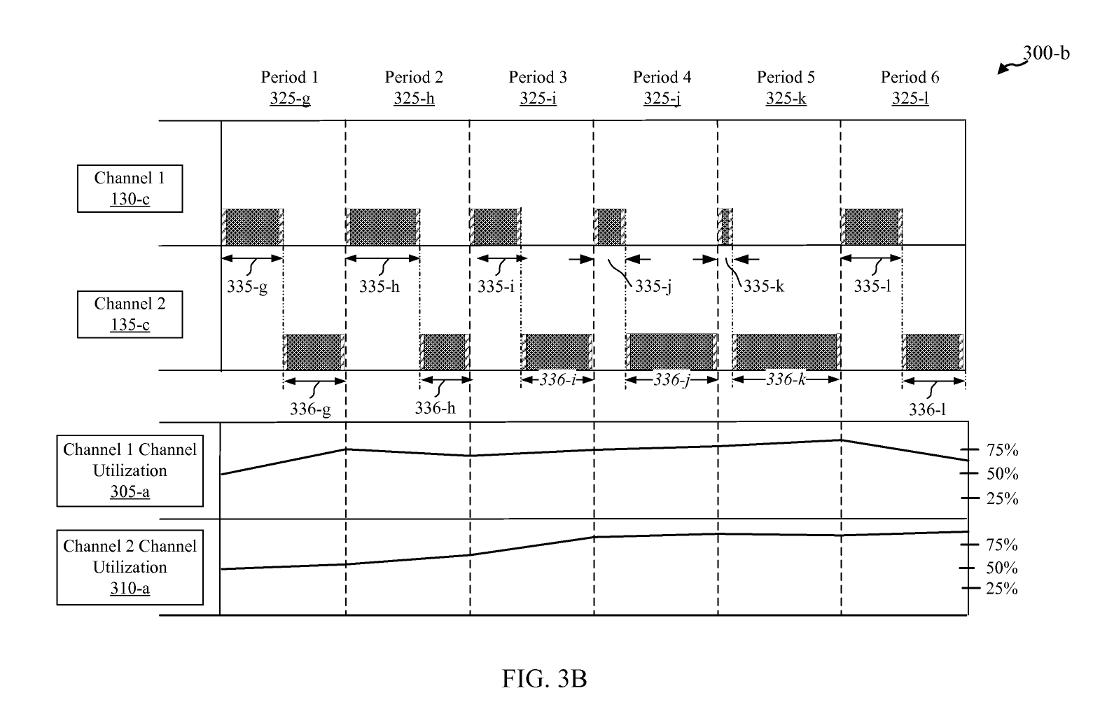

Referring now to FIG. 3A, a timing diagram 300-a shows how dwell times across channels 1 and 2, 130-b and 135-b, utilized by a single radio of a device 110, can be adapted relative to the respective channel utilizations 305 and 310. In some embodiments, an MCC scheduler, or a program, algorithm, or control mechanism implementing an MCC scheduler, of a device 110 can adapt channel dwell times across channels 130-b, 135-b based on channel utilizations 305, 310 as illustrated in timing diagram 300-a. Channel 1, 130-b and channel 2, 135-b, for example, may represent any of channels 130 and 135 of FIG. 1, or channels 130-a between an AP 105-a and a mobile device 110-a and channel 135-a between the mobile device 110-a and a display device 110-b of FIG. 2. However, Channel 1, 130-b and channel 2, 135-b may also represent any other combination of channels 130, 135 concurrently supported by a single radio of a device 110.

Channel dwell times and channel utilizations 305 and 310 for the two channels 130-b, 135-b are shown relative to dwell periods 315-a-315-f. In some examples, dwell periods 315 may correspond to a beacon period of one or both of the channels 130-b, 135-b. A single radio of the device may transmit and receive data over channels 130-b, 135-b during dwell times 335, 336, respectively, which each include a time of actual data transmission/reception 320, and may include initialization time 325 and buffer time 330. As illustrated in FIG. 3A and as will be described below, channel utilizations 305, 310 may be measured at the end of each period 315, and ‘N’ measured channel utilizations 305, 310 may be aggregated to determine dwell times 335, 336 for subsequent dwell periods 315. While FIG. 3A illustrates an example where ‘N’ is equal to 1, any suitable averaging or filtering technique may be used to aggregate additional values of ‘N.’ In addition, channel utilizations 305, 310 may be measured at other or additional times, such as midway during a dwell period 315, measured continuously, etc., to provide input for scheduling decisions to be made to allocate different dwell times 335, 336 to each of the channels 130-b, 135-b. In addition, there may be a delay between a time that channel utilizations 305, 310 are measured and a time when channel dwell times 335, 336 are adjusted.

In the example illustrated in FIG. 3A, the channel dwell times 335-a, 336-a of the two channels 130-b, 135-b may be of equal length during a first dwell period 315-a. The ratio of time between dwell times 335-a and 336-a may represent a default dwell time ratio of 50/50, which may be set upon channel initialization. As illustrated in FIG. 3A, channel 1 utilization 305 may start near 50% and increase to approximately 60% during dwell period 315-a, while channel 2 utilization 310 may start around 50% and decrease to around 35% during dwell period 315-a. Channel utilization, such as channel 1 utilization 305, may increase during dwell period 315-a, or any other period, for example, due to an increase in data being transmitted or received over that channel 130-b, a reduction in channel capacity (e.g., increase in channel noise), or other channel conditions as described above. Furthermore, channel utilization, such as channel 2 utilization 310, may decrease during a dwell period 315 due to changes in channel conditions or due to a decrease in data to transmit or receive during the dwell period 315.

It should be understood that the channel utilizations 305, 310 and channel dwell times 335, 336 are only examples for purposes of explanation. Channel utilizations 305, 310 may change relative to each other and relative to channel dwell times 335, 336 in a different relationship than is shown, such as with different data traffic across each channel, different channel conditions, different latency/priority information, etc.

As illustrated, channel 1 dwell time 335-b may be increased during a next dwell period 315-b in response to the previous increase in channel utilization 305, and/or the relative divergence of channel utilizations 305, 310 at the end of period 315-a. Similarly, the channel 2 dwell time 336-b may be decreased during dwell period 315-b in response to the decrease in channel 2 utilization 310 during the previous dwell period 315-a, which may be measured at the end of the dwell period 315-a. Channel dwell times 335, 336 may be adapted relative to channel utilizations 305, 310 across multiple dwell periods 315-a through 315-f, in a similar manner.

In some cases, where the channel utilizations 305, 310 are close to being equal, for example within 5% of each other, the channel dwell times 335, 336 may be kept constant from one dwell period 315 to the next. For example, as illustrated, channel 1 utilization 305 at the end of dwell period 315-b may equal approximately 50%, whereas the channel 2 utilization may equal approximately 45%. In this scenario, the dwell times 335-b, 336-b during dwell period 315-b may be unchanged for the next dwell period 315-c, such that dwell times 335-b, 336-b equal dwell times 335-c, 336-c.

In yet other embodiments, if channel utilizations 305, 310 are both below a threshold, such as 20% utilization, no dwell time adjustments may be performed during a subsequent dwell period 315, as performance increases in the channels may not be experienced when both channels are under-utilized.

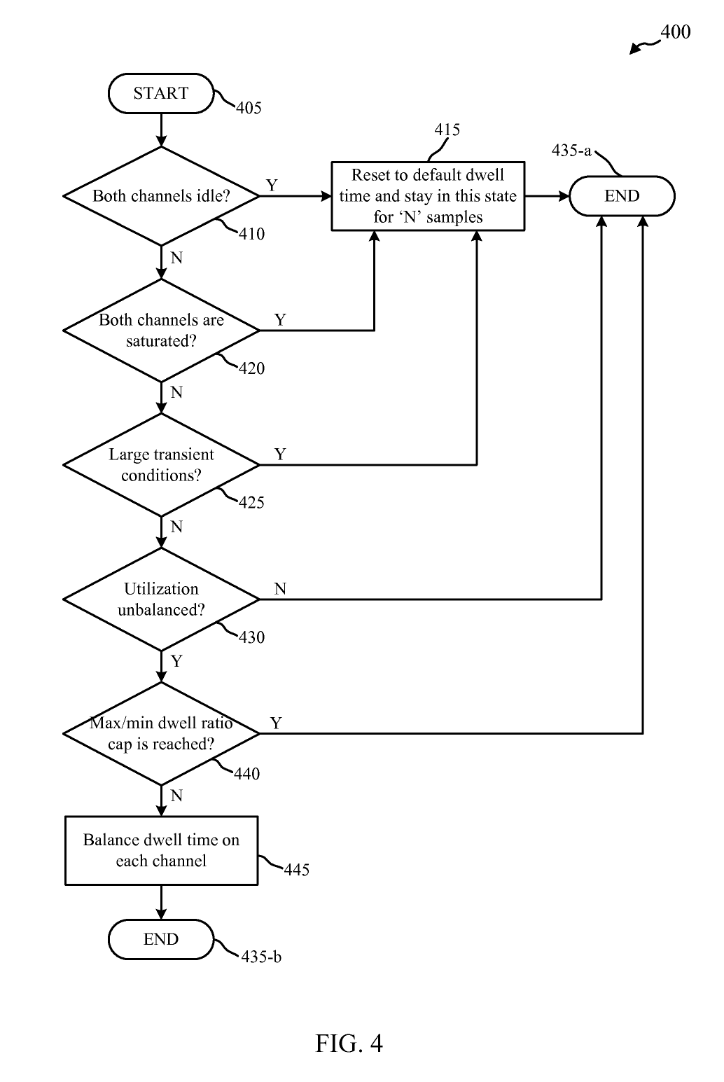

In some embodiments, certain channel utilization values and/or other factors, such as certain channel conditions, may trigger resetting the dwell times across two or more channels to default dwell times. FIG. 4 illustrates a process 400 that may be implemented by an MCC scheduler, program, processor, etc., to control the resetting of channel dwell times to default dwell times based on a number of conditions. In some cases, process 400 may be utilized by a wireless device 110 performing MCC as illustrated in FIGS. 1, 2, and/or 3.

The algorithm or process 400 may begin at block 405 and proceed to block 410, where the MCC scheduler can determine if both channels, which may be channels 130, 135 of FIG. 1 or FIG. 2, are idle. In some embodiments, an idle condition may be pre-configured, or alternatively set based on a recent history of channel conditions, etc. Upon both links becoming idle, the dwell ratio may be reset to a default dwell ratio (e.g., 50/50, etc.) at block 415. An idle condition may be determined by:
If U_{A}<=U_{idle} && U_{B}<=U_{idle}, reset dwell ratio to the default dwell ratio;
   where U_{A} is the channel utilization of channel A; U_{B} is the channel utilization of channel B; U_{idle} is a predetermined idle channel utilization, which can be set at 5%, 10%, 20%, 30%, or any other such value.

Once the channel dwell times of the two channels are reset to the default dwell ratio at block 415, normal operation may be resumed at block 435-a and the dwell times may be adapted based on channel utilization as described above. Optionally, at block 415, the default dwell ratio may be used for ‘N’ samples, which may clear the filtering or averaging of results from prior to resetting the dwell ratio. In this way, the default condition may provide a new starting point for balancing (or some other predetermined channel utilization ratio) channel utilization.

If both channels are not determined to be idle at block 410, process 400 may proceed to block 420, where it can be determined whether both channels are saturated. If both channels are saturated (e.g., channel utilization over a threshold Uₛₐₜ) the channels can be reset to a default dwell ratio (e.g., 50/50, etc.) at block 415 as described above. A saturation condition may be determined by:
If U_{A}>=Uₛₐₜ && U_{B}>=Uₛₐₜ: the dwell ratio can be reset to the default dwell ratio,
   where U_{A} is the channel utilization of channel A; U_{B} is the channel utilization of channel B; and Uₛₐₜ is a predetermined saturated channel utilization, such as 70%, 80%, etc.

Additionally, when a given channel's utilization is higher than the other, and by course of the algorithm, more time is given to the busier channel, but the utilization percentages of each channel do not converge, then adjustment action may be taken. This type of condition may be considered a type of saturation condition. Accordingly, it may be beneficial to limit the dwell spread under these conditions to less than a maximum spread, e.g., 70/30 or 65/35 instead of 80/20, for example.

If either channel is not saturated at block 420, then process 400 may continue to block 425 where it can be determined if any large transient conditions exist on either of the channels. These transient conditions may be pre-configured, or alternatively set based on a recent history of channel conditions, etc. If a large transient condition is detected at block 425, the channels can be reset to a default dwell ratio (e.g., 50/50, etc.) at block 415 as described above.

For example, if the CCA noise value on a channel changes by more than a certain percentage between samples, the dwell ratio between channels may be reset to a default dwell ratio, such as 50/50 across the channels. This may be represented by:
If Δ CCA>=Y % over a given time period, such as between samples, reset dwell ratio to default dwell ratio;
where Y % is a predetermined percentage, such as 50%, 60%, 70%, 80%, or any other selected percentage.

Another indicator of large transient conditions may be large changes in channel utilization. In some embodiments, changes in channel utilization by more than a given percentage triggers resetting of dwell time ratios. This may be represented by:
If |U_{A}−U′_{A}| or |U_{B}−U′_{B}|>=YY %; the dwell time can be reset to a default dwell time;
   where U′_{A} is a previous channel utilization for channel A, U′_{B} is a previous channel utilization of channel B, and YY % is a predetermined channel utilization delta, such as 30%, 40%, 50%, 60%, 70%, or any other such percentage.

If no large transient conditions exist at block 425, process 400 may proceed to block 430, where it can be determined if the channel utilizations are unbalanced (e.g., not meeting the target channel utilization ratio, etc.). If the channel utilizations are balanced, then process 400 may end at block 435-a. However, if the channel utilizations are unbalanced, it may next be determined if any maximum or minimum dwell ratio thresholds have been reached at block 440.

In some embodiments, the maximum/minimum dwell ratios may be capped, such as to an 80/20 time distribution. This limit may be enforced to ensure a minimum time is always available for new traffic to start or existing traffic to suddenly increase.

In some embodiments, priority or latency information, such as a maximum latency for a particular channel, may inform the target channel utilization ratio or the maximum or minimum dwell ratio cap set for the MCC channels. For example, a maximum latency of a first channel may equate to a maximum dwell time on other channels. This maximum dwell time may then, with information of a dwell period length and a number of channels utilized in a concurrent session, be used to calculate a minimum/maximum dwell ratio cap for the other channels.

In addition to the above techniques, some embodiments may also include adjusting the channel dwell periods to better balance channel utilizations. Adjusting the dwell periods, for example, may be performed if prior attempts to balance channel utilizations have failed and/or have failed to meet priority and/or latency requirements of one or more of the channels.

In some implementations, if the maximum or minimum thresholds have been reached, the process 400 may end at block 435-a. If no thresholds have been reached, process 400 may continue to block 445 where the dwell times on each channel may be adapted to converge the channel utilization to a target channel utilization ratio (e.g., balanced, etc.). The target channel utilization ratio may be informed by latency and/or priority information for the channels as described above. The process flow 400 may then end at a block 435-b and be re-started at the next sample period.

The process flow 400 described above is only given as an example. The blocks of process 400 may be rearranged, some block omitted, etc., based on channel needs, traffic considerations, and other similar considerations. It should be understood that the values described above are only for the purpose of example. The reset or default dwell time/percentages, saturation, idle, and other such values may be set according to needs of the link, type of data transmitted over the link, and other conditions described herein.

In reference now to FIG. 3B, a timing diagram 300-b illustrates how process 400 for resetting channel dwell times to default dwell times may be used in conjunction with adapting channel dwell times based on channel utilizations for two channels. In particular, dwell times 335, 336 across channels 1 and 2, 130-c and 135-c, can be adapted relative to the respective channel utilizations 305-a and 310-a. In some embodiments, an MCC scheduler can adapt channel dwell times 335, 336 across channels 130-c, 135-c during dwell periods 315-g through 315-1, based on channel utilizations 305-a, 310-a as described above in reference to FIG. 3A. Channel 1, 130-c and channel 2, 135-c, for example, may represent any of channels 130 and 135 of FIG. 1, or channels 130-a between an AP 105-a and a mobile device 110-a and channel 135-a between the mobile device 110-a and a display device 110-a of FIG. 2. However, channel 1, 130-c and channel 2, 135-c may also represent any other combination of channels concurrently supported by a single radio of a device.

During a first dwell period 315-g of timing diagram 300-b, channel dwell times 335-g and 336-g may be initialized at default dwell times, for example a ratio of 50/50. Due to changing channel conditions, changes in data loading of the channels, etc., channel utilizations 305-a, 310-a may continue to increase during dwell periods 315-g through 315-k. In accordance with the techniques described above, the channel dwell times 335, 336 may be adapted based on the channel utilizations 305-a, 310-a during the dwell periods 315-g through 315-k. However, both channel utilizations 305-a, 310-a may continue to increase regardless of adapting the channel dwell times 335, 336 to balance channel utilizations 305-a, 310-a. As described above, this may be referred to as a channel saturation condition. Furthermore, as channel dwell times 335, 336 increase to account for the increasing channel utilizations 305-a, 310-a, one or both of the channel dwell times 335, 336 may meet or exceed a maximum dwell ratio cap, for example 85%. In response to one or both of these conditions being detected by an MCC scheduler during dwell period 315-k, such as via process 400, channel dwell times 335, 336 may be reset to default dwell times, such as a ratio of 50/50 during the next dwell period 315-1. The reset condition may be held for a sample period ‘N’ and subsequently the dwell ratio may be allowed to re-converge to the predetermined channel utilization ratio (e.g., balanced channel utilization, etc.).

Other reset conditions, as described above, may be utilized in conjunction with adapting channel dwell times based on channel utilizations to improve channel utilizations. Furthermore, priority and/or latency information of one or more of the channels may also be accounted for in adjusting channel dwell times based on channel utilizations.

The above examples have described methods for adapting channel dwell times based on channel utilizations, channel reset conditions, and latency/priority information for one or more of the channels, with respect to two channels. It should be appreciated that any number of channels may be used concurrently by a single radio of a device, such as device 110, with dwell times of those channels being adapted and/or reset via similar techniques.

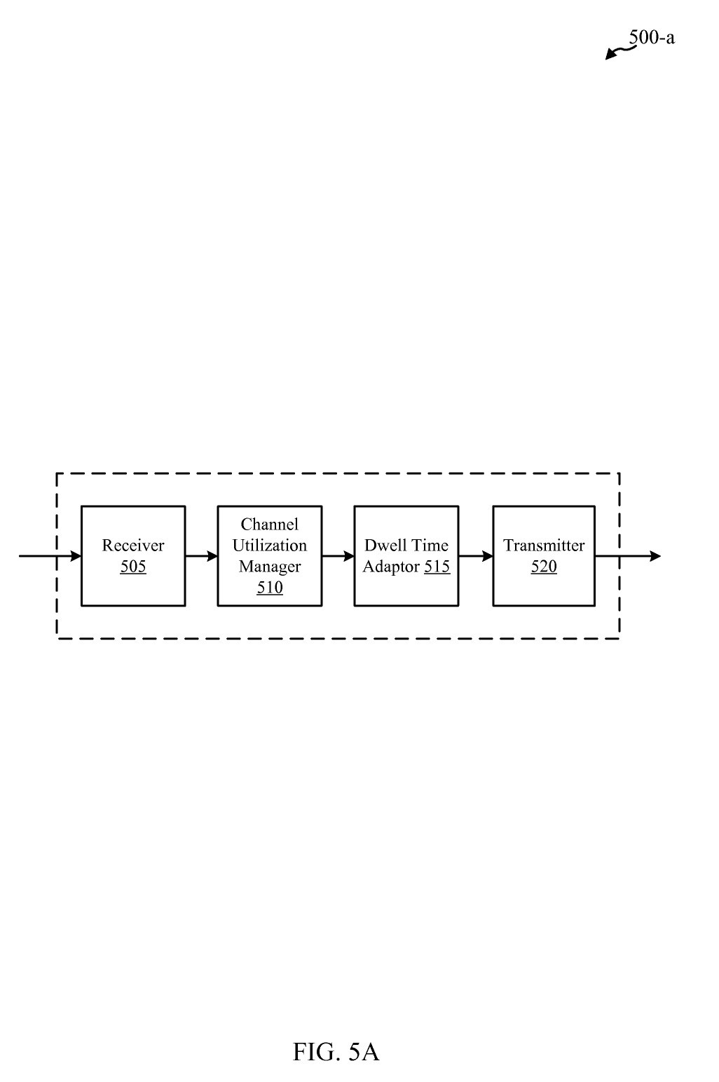

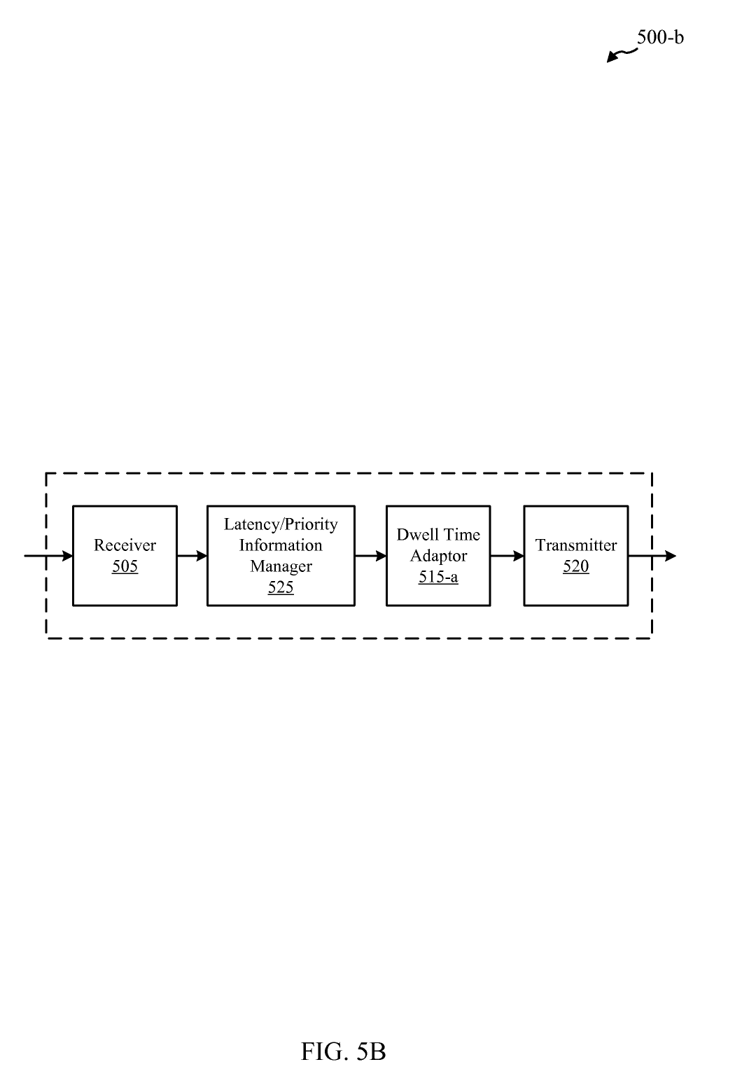

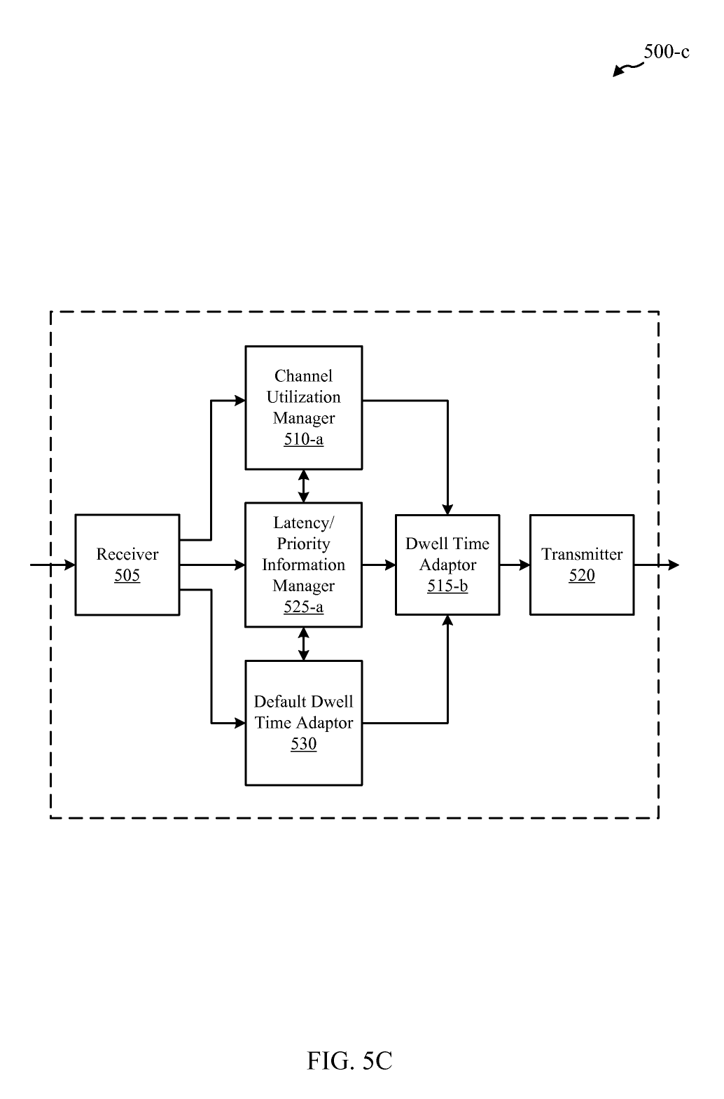

FIG. 5A shows a block diagram illustrating an example of a device 500-a that may be configured for dynamically scheduling channel time allocations across two or more channels using a single radio in accordance with various embodiments. The device 500-a may be an example of one or more aspects of the devices 110 described with reference to FIG. 1, or devices 110-a, 110-b of FIG. 2. The device 500-a may include a receiver 505, a channel utilization manager 510, a dwell time adaptor 515, and/or a transmitter 520, each of which, in embodiments, may be communicably coupled with any or all of the other components.

The receiver 505 may be used to receive various types of data and/or control signals over a wireless communications system such as the wireless communications systems 100 and/or 200 as shown in FIGS. 1 and 2. As such, the receiver 505, either alone or in combination with other components, may be means for communicating as described herein.

The transmitter 520 may be used to transmit various types of data and/or control signals over a wireless communications system such as the wireless communications systems 100 and/or 200. As such, the transmitter 520, either alone or in combination with other components, also may be means for communicating.

As described herein, the receiver 505 and the transmitter 520 may make up a single radio of device 500-a that may be configured for supporting communications concurrently on two or more channels, such as channels 130, 135 described above. For the sake of explanation, device 500-a is only shown with a single radio, however, it should be appreciated that device 500-a may include N number of radios that operate in the manner described below to support M number of concurrent channels, where M>N. The single radio 505, 520 of device 500-a may transmit and receive over two channels 130, 135, which may be on different frequencies. As a result, the single radio 505, 520 of device 500-a may tune to the different frequencies of the two channels 130, 135 during the dwell time of each channel 130, 135 to support concurrent operation.

The channel utilization manager 510 of device 500-a may obtain and determine channel utilization information of two or more channels concurrently utilized on a radio of device 500-a, as described above with respect to FIGS. 1, 2, 3A, 3B, and/or 4. For example, the channel utilization manager 510 may obtain or measure the amount of transmit and receive traffic on a channel in a given time period, a noise level on the channel, and MAC and transport layer efficiencies of the channel via receiver 505. The channel utilization manager 510 may then determine a theoretical throughput (aka channel capacity) of the channel based on this received/measured information. The channel utilization manager 510 may then calculate a channel utilization for the channel.

The dwell time adaptor 515 may adapt dwell times of the multiple channels according to channel utilizations determined by the channel utilization manager 510 of device 500-a. For example, the dwell time adaptor 515 may receive the calculated channel utilizations from the channel utilization manager 510. The dwell time adaptor 515 may then adjust channel dwell times across the one or more channels based on the received channel utilizations according to the techniques described above. The adjustment of dwell times of the multiple channels may be implemented via the receiver 505 and the transmitter 510.

FIG. 5B shows a block diagram illustrating an example of a device 500-b that may be configured for dynamically scheduling channel time allocations across two or more channels utilized by a single radio in accordance with various embodiments. The device 500-a may be an example device 500-b of FIG. 5A, or of one or more aspects of the devices 110 described with reference to FIG. 1, or devices 110-a, 110-b of FIG. 2. The device 500-b may include a receiver 505, a latency/priority information manager 525, a dwell time adaptor 515-a, and/or a transmitter 520, each of which, in embodiments, may be communicably coupled with any or all of the other components.

The receiver 505 and the transmitter 520 may be implemented and may possess the same functionality as described above with respect to FIG. 5A. As such, for the sake of brevity, these components will not be described further here.

The latency/priority information manager 525 may obtain and prioritize latency information and/or priority information of a channel received via the receiver 505, as described above with respect to FIGS. 1, 2, 3A, 3B, and/or 4. For example, the latency/priority information manager 525 may receive a maximum latency that a channel may require, or a minimum throughput that a channel needs. Upon reception of this information, the latency/priority information manager 525 may communicate the information to the dwell time adaptor 515-a.

The dwell time adaptor 515-a may use the latency and/or priority information to adapt dwell times of multiple channels supported by receiver 505 and transmitter 510 via the techniques described above. For example, the dwell time adaptor 515-a may adjust the dwell times across multiple channels to ensure that a specified channel always maintains a minimum throughput or maximum latency. The dwell times of the multiple channels may be implemented via the receiver 505 and the transmitter 510.

FIG. 5C shows a block diagram illustrating an example of a device 500-c that may be configured for dynamically scheduling channel time allocations across two or more channels utilized by a single radio in accordance with various embodiments. The device 500-c may be an example device 500-a of FIG. 5A, device 500-b of FIG. 5B, or of one or more aspects of the devices 110 described with reference to FIG. 1, or devices 110-a, 110-b of FIG. 2. The device 500-c may include a receiver 505, a channel utilization manager 510-a, a latency/priority information manager 525-a, a default dwell time adaptor 530, a dwell time adaptor 515-b, and/or a transmitter 520, each of which, in embodiments, may be communicably coupled with any or all of the other components.

The receiver 505 and the transmitter 520 may be implemented and may possess the same functionality as described above with respect to FIGS. 5A and 5B. As such, for the sake of brevity, these components will not be described further here.

The channel utilization manager 510-a of device 500-b, which may incorporate some or all aspects of the channel utilization manager 510-a of FIG. 5A, may obtain and determine channel utilization information of two or more channels concurrently utilized on a radio of device 500-c, as described above with respect to FIGS. 1, 2, 3A, 3B, 4, and/or 5A. For example, the channel utilization manager 510-a may obtain or measure the amount of transmit and receive traffic on a channel in a given time period, a noise level on the channel, and MAC and transport layer efficiencies of the channel via receiver 505. The channel utilization manager 510 may then determine a channel capacity of the channel based on this received/measured information. The channel utilization manager 510 may then calculate a channel utilization for the channel and communicate this information to the dwell time adaptor 515-b.

In addition, the latency/priority information manager 525-a may obtain and prioritize latency information and/or priority information of a channel received via the receiver 505, as described above with respect to FIGS. 1, 2, 3A, 3B, 4, and/or 5B. For example, the latency/priority information manager 525-a may receive a maximum latency that a channel may require, or a minimum throughput that a channel needs. Upon reception of this information, the latency/priority information manager 525-a may communicate the information to the dwell time adaptor 515-b.

In some embodiments, a default dwell time adaptor 530 may also be implemented in device 500-c. The default dwell time adaptor 530 may obtain information of the one or more channels via the receiver 505, and set default dwell times for multiple channels based on the received information, as described above with respect to FIGS. 1, 2, 3A, 3B, and/or 4. For example, a channel utilization ratio across two or more channels may be set unevenly based on channel considerations such as data traffic, priority, latency, etc. The default dwell time adaptor 530 may communicate these default dwell times to the dwell time adaptor 515-b.

The dwell time adaptor 515-b may then adapt dwell times of the multiple channels according to channel utilizations determined by the channel utilization manager 510, latency/priority information received from the latency/priority information manager 525-a, and/or default dwell times received from the default dwell time adaptor 530 using the techniques described above with respect to FIGS. 1, 2, 3A, 3B, 4, 5A, and/or 5B.

Although the above examples have been described in reference to a single device, the various components of devices 500 may be implemented at different locations from one another, such as across a network 100, 200, or across multiple devices 110 and/or APs 105.

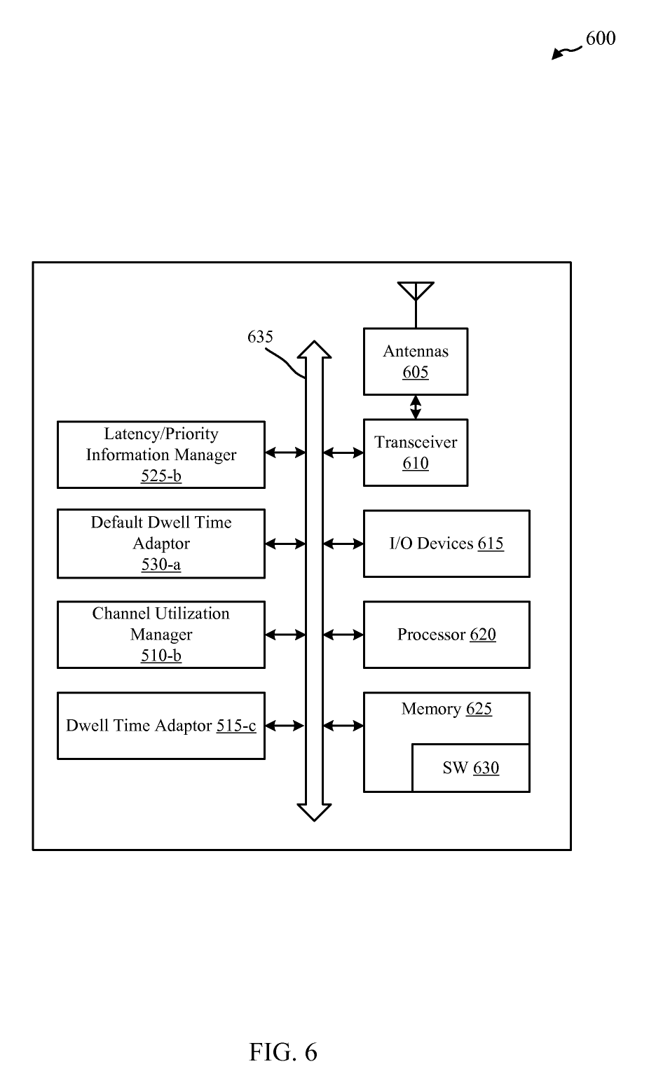

FIG. 6 is a block diagram of a device 600 configured for dynamically scheduling channel time allocations across two or more channels utilized by a single radio in accordance with various embodiments. Device 600 may be, for example, any wireless device 110 of FIG. 1, mobile device 110-a and/or display device 110-b of FIG. 2, and/or devices 500-a-500-c of FIGS. 5A-5C. The device 600 may have any of various configurations, such as personal computers (e.g., laptop computers, netbook computers, tablet computers, etc.), smartphones, cellular telephones, PDAs, wearable computing devices, digital video recorders (DVRs), internet appliances, gaming consoles, e-readers, display devices, printers, etc. The device 600 may have an internal power supply (not shown), such as a small battery, to facilitate mobile operation.

The device 600 includes antenna(s) 605, a transceiver 610, memory 625, a processor 620, and I/O devices 615 (e.g., a display, touch-screen interface, buttons, etc.), which each may be in communication, directly or indirectly, with each other, for example, via one or more buses 635. The transceiver 610 is configured to communicate bi-directionally, via the antennas 605 over one or more wired or wireless links 130, 135, as described above. For example, the transceiver 610 may be configured to communicate bi-directionally with other wireless devices 110 and/or APs 105 via communication links, such as links 130, 135 as described above with reference to FIGS. 1-4 (not shown). The transceiver 610 may include a modem configured to modulate the packets and provide the modulated packets to the antennas 605 for transmission, and to demodulate packets received from the antennas 605. The transceiver 610 may be configured to maintain multiple concurrent communication links using the same or different radio interfaces (e.g., Wi-Fi, cellular, etc.). The device 600 may include a single antenna 605, or the device 600 may include multiple antennas 605. The device 600 may be capable of employing multiple antennas 605 for transmitting and receiving communications in a MIMO communication system.

The memory 625 may include random access memory (RAM) and read-only memory (ROM). The memory 625 may store computer-readable, computer-executable software code 630 containing instructions that are configured to, when executed, cause the processor 620 to perform various functions described herein (e.g., Wi-Fi Display, dynamic configuration of sink buffer size, etc.). Alternatively, the software 630 may not be directly executable by the processor 620 but may be configured to cause the computer (e.g., when compiled and executed) to perform functions described herein. The processor 620 may include an intelligent hardware device, e.g., a central processing unit (CPU), a microcontroller, an application specific integrated circuit (ASIC), etc.

According to the architecture of FIG. 6, the device 600 further includes a channel utilization manager 510-b, a latency/priority information manager 525-b, a default dwell time adaptor 530-a, and a dwell time adaptor 515-c. By way of example, these components of the device 600 may be in communication with some or all of the other components of the device 600 via bus 635. Additionally or alternatively, functionality of these components may be implemented via the transceiver 610, as a computer program product stored in software 630, and/or as one or more controller elements of the processor 620.

The channel utilization manager 510-b may determine channel utilizations for multiple channels using information received from the transceiver 610 and antennas 605, via techniques described above in reference to FIGS. 1-4. The channel utilization manager 510-b may be an example of channel utilization managers 510 of FIGS. 5A and 5C. The channel utilization manager 510-b may then communicate this information via bus 635 to the processor 620, memory 625, and/or the dwell time adaptor 515-c to adapt channel dwell times according to the techniques described above.

The latency/priority information manager 525-b may obtain and prioritize latency information and/or priority information of a channel, via techniques described above in reference to FIGS. 1-4. The latency/priority information manager 525-b may incorporate some or all aspects of latency/priority information managers 525 of FIGS. 5B and 5C. The latency/priority information manager 525-b may then communicate this information via bus 635 to the processor 620, memory 625, and/or the dwell time adaptor 515-c to perform adaption of channel dwell times according to the latency and/or priority information.

The default dwell time adaptor 530-a may obtain information of the one or more channels via the transceiver 610 and antennas 605, and set default dwell times for multiple channels using the obtained information, as described above with respect to FIGS. 1-4. The default dwell time adaptor 530-a may be an example of default dwell time adaptor 530 of FIG. 5C. The default dwell time adaptor 530-a may communicate the default dwell time information via bus 635 to the processor 620, memory 625, and/or the dwell time adaptor 515-c to further inform adaption of channel dwell times based on reset conditions.

The dwell time adaptor 515-c may then compile information received from the channel utilization manager 510-b, the latency/priority information manager 525-b, and/or the default dwell time adaptor 530-a and adapt dwell times of the multiple channels according to the compiled information, according to the techniques described above in reference to FIGS. 1-4. The dwell time adaptor 515-c may incorporate some or all aspects of dwell time adaptors 515, 515-a, and/or 515-b of FIGS. 5A-5C. The dwell time adaptor 515-c may effectuate the modified channel dwell times via the transceiver 610 and antennas 605. Alternatively or additionally, the dwell time adaptor 515-c may communicate the channel dwell times via bus 635 to the processor 620, and/or memory 625 to further implement the dwell times and/or store the dwell time information for later use, etc.

The components of the device 600 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted components may be a means for performing one or more functions related to operation of the device 600.

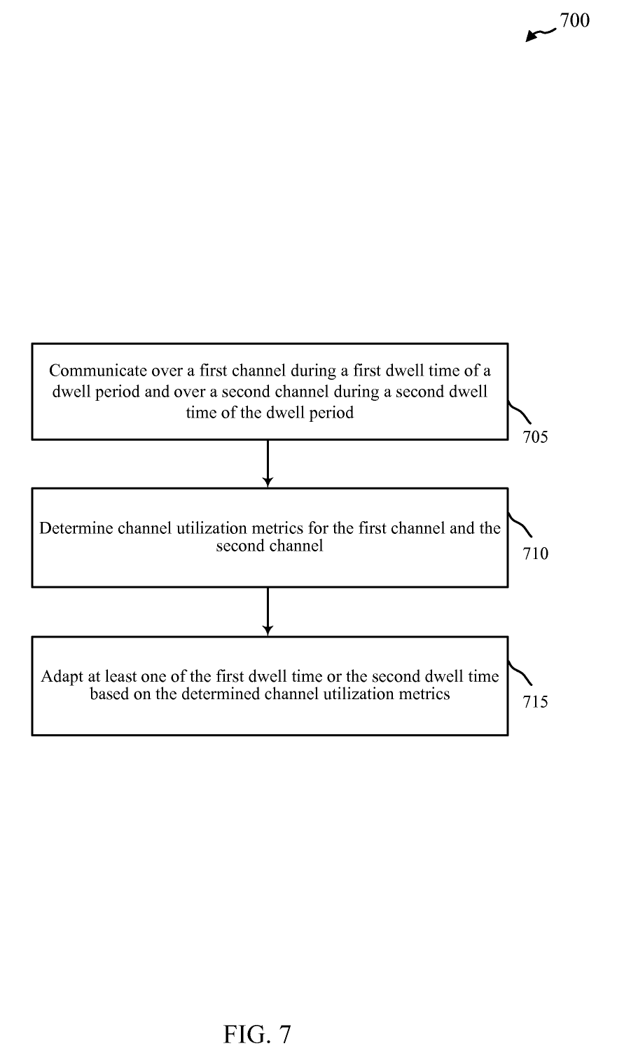

FIG. 7 is a flow chart illustrating one example of a method 700 for dynamically scheduling channel time allocations across two or more channels utilized by a single radio in accordance with various embodiments. For clarity, the method 700 is described below with reference to one or more aspects of one of the devices 110 described with reference to FIG. 1 or 2, devices 500 described in reference to FIG. 5A or 5C, or device 600 described in reference to FIG. 6. In some embodiments, a device such as one of the devices 110 may execute one or more sets of codes to control the functional elements of the device 110 to perform the functions described below.

At block 705, a device, such as device 110 of FIG. 1 or 2, device 500 of FIG. 5A or 5C, or device 600 of FIG. 6, may communicate (e.g., via receiver/transmitter 505, 520, via transceiver 610 and antennas 605, etc.) over a first channel during a first dwell time of a dwell period and over a second channel during a second dwell time of the dwell period. In some embodiments, the device may communicate with an AP 105 over the first channel, which may by a Wi-Fi communication link, and with a second device 110 over the second channel, which may be a Wi-Fi-Direct communication link. The first and second channels may be in different Wi-Fi frequency bands.

At block 710, the device may determine (e.g., via channel utilization manager 510, etc.) channel utilization metrics for the first channel and the second channel. In some embodiments, the channel utilization metrics may be based on ratios of transmitted and received traffic during a sample period divided by channel capacities for the first and second channels. The channel utilization metrics may be further based on the physical link speed of the respective channel, a proportion of time the respective channel is available to transmit, a medium access control (MAC) layer protocol efficiency of the respective channel, and/or a transport layer protocol efficiency of the respective channel. In some cases, the channel utilization metrics may be based on an aggregation of channel utilization metrics measured or determined over multiple sample periods.

At block 715, the device may adapt at least one of the first dwell time or the second dwell time based on the determined channel utilization metrics. In some embodiments, the first and/or second dwell times may not be adjusted above a predetermined maximum dwell time. The predetermined maximum dwell time may be based on a ratio of the first and second dwell times. In further embodiments, the first and/or second dwell times may be adjusted by an amount proportionate to a determined difference between the first and second channel utilization metrics. The operation(s) at block 715 may in some cases be performed using the dwell time adaptor 515, the channel utilization manager 510, receiver 505, transmitter 520, and/or the transceiver 610 and antennas 605 described with reference to FIG. 5A, 5C, or 6.

In some embodiments, method 700 may be performed by any of devices 500-a, 500-c, or 600 as described above in reference to FIGS. 5A, 5C, and 6. For example, the receiver 505 and transmitter 520, or the transceiver 610 and antennas 605 may in conjunction with the channel utilization manager 510 determine channel utilization metrics for a first and second channel. The dwell time adaptor 515 may in conjunction with the receiver 505 and transmitter 520 or the transceiver 610 and antennas 605 adapt at least one of the first dwell time or the second dwell time based on the determined channel utilization metrics.

Thus, the method 700 may provide for dynamically scheduling channel time allocations across two or more channels utilized by a single radio. It should be noted that the method 700 is just one implementation and that the operations of the method 700 may be rearranged or otherwise modified such that other implementations are possible.

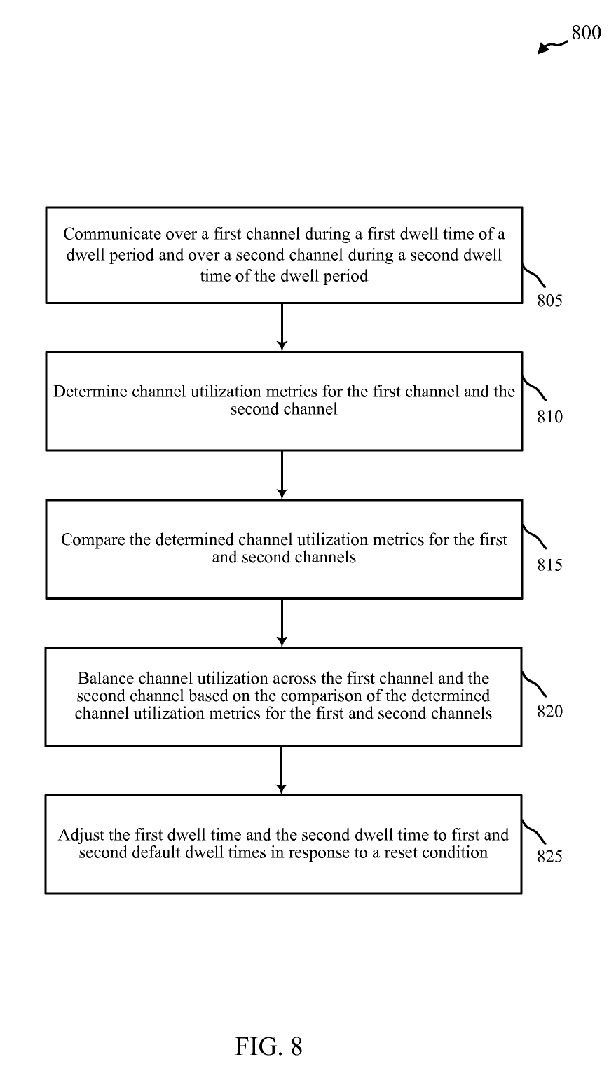

FIG. 8 is a flow chart illustrating one example of another method 800 for dynamically scheduling channel time allocations across two or more channels utilized by a single radio in accordance with various embodiments. For clarity, the method 800 is described below with reference to one or more aspects of one of the devices 110 described with reference to FIG. 1 or 2, devices 500 described in reference to FIG. 5A or 5C, or device 600 described in reference to FIG. 6. In some embodiments, a device such as one of the devices 110 may execute one or more sets of codes to control the functional elements of the device 110 to perform the functions described below.

At block 805, a device, such as device 110 of FIG. 1 or 2, device 500 of FIG. 5A or 5C, or device 600 of FIG. 6 may communicate over a first channel during a first dwell time of a dwell period and over a second channel during a second dwell time of the dwell period.

At block 810, the device may determine channel utilization metrics for the first channel and the second channel.

At block 815, the device may compare the determined channel utilization metrics for the first and second channels.

At block 820, the device may balance channel utilization across the first channel and the second channel based on the comparison of the determined channel utilization metrics for the first and second channels.

At block 825, the device may adjust the first dwell time and the second dwell time to first and second default dwell times in response to a reset condition. In some embodiments, the reset condition may include a change in the channel utilization metrics for the first or second channels over a sample period being greater than a predetermined change threshold, a noise level on the first or second channels exceeding a predetermined noise threshold, a change in noise level for the first or second channels exceeding a predetermined noise change threshold, the channel utilization metrics for the first or second channels exceeding a first predetermined threshold, and/or the channel utilization metrics for the first and second channels being less than a second predetermined threshold. In some cases, the first and second default dwell times may be equal.

In some embodiments, method 800 may be performed by any of devices 500-c or 600 as described above in reference to FIGS. 5C and 6. For example, the receiver 505 and transmitter 520, or the transceiver 610 and antennas 605 may, in conjunction with the channel utilization manager 510, determine channel utilization metrics for a first and second channel. The dwell time adaptor 515 may in conjunction with the receiver 505 and transmitter 520 or the transceiver 610 and antennas 605 balance channel utilizations across the first and second channels based on a comparison of the determined channel utilization metrics. The default dwell time adaptor 530 may then adjust the first dwell time and the second dwell time to first and second default dwell times in response to a reset condition.

Thus, the method 800 may provide for dynamically scheduling channel time allocations across two or more channels utilized by a single radio. It should be noted that the method 800 is just one implementation and that the operations of the method 800 may be rearranged or otherwise modified such that other implementations are possible.

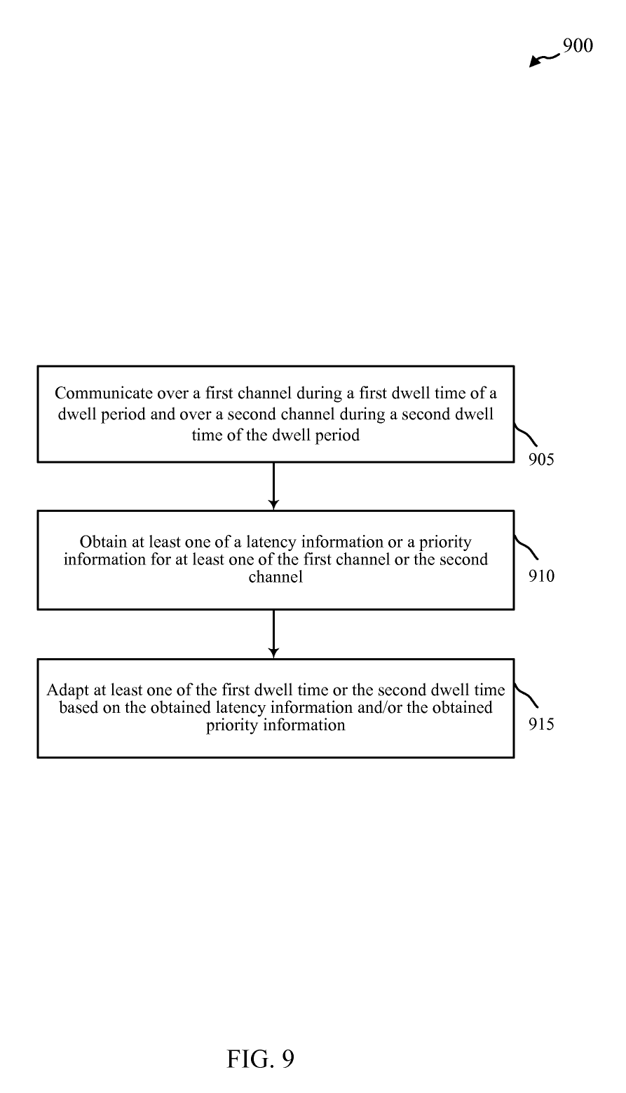

FIG. 9 is a flow chart illustrating one example of another method 900 for dynamically scheduling channel time allocations across two or more channels utilized by a single radio in accordance with various embodiments. For clarity, the method 900 is described below with reference to one or more aspects of one of the devices 110 described with reference to FIGS. 1 and/or 2, device 500-b described in reference to FIG. 5B, and/or device 600 described in reference to FIG. 6. In some embodiments, a device such as one of the devices 110 may execute one or more sets of codes to control the functional elements of the device 110 to perform the functions described below.

At block 905, a device, such as device 110 of FIGS. 1 and/or 2, device 500-b of FIG. 5B, or device 600 of FIG. 6 may communicate over a first channel during a first dwell time of a dwell period and over a second channel during a second dwell time of the dwell period.

At block 910, the device may obtain at least one of a latency information or a priority information for at least one of the first channel or the second channel. The latency information and/or the priority information may relate to the type of traffic on a traffic session associated with the first and/or second channel. In some cases, the priority information may include a first priority including a maximum delay value and/or a second priority including a minimum throughput value for one or more of the first and second channels.

At block 915, the device may adapt at least one of the first dwell time or the second dwell time based on the obtained latency information and/or the obtained priority information. In some embodiments, adapting the first and/or second dwell times may include setting an upper dwell time limit and/or a lower dwell time limit for the first and/or second channel based on the priority or latency information.

In some embodiments, method 900 may be performed by any of devices 500-b, 500-c, or 600 as described above in reference to FIGS. 5B, 5C, and 6. For example, the receiver 505 and transmitter 520, or the transceiver 610 and antennas 605 may in conjunction with the latency/priority information manager 525 obtain latency and/or priority information for at least one of the first or second channels. The dwell time adaptor 515 may in conjunction with the receiver 505 and transmitter 520 or the transceiver 610 and antennas 605 adapt at least one of the first dwell time or the second dwell time based on the obtained latency and/or priority information.

Thus, the method 900 may provide for dynamically scheduling channel time allocations across two or more channels utilized by a single radio. It should be noted that the method 900 is just one implementation and that the operations of the method 900 may be rearranged or otherwise modified such that other implementations are possible.

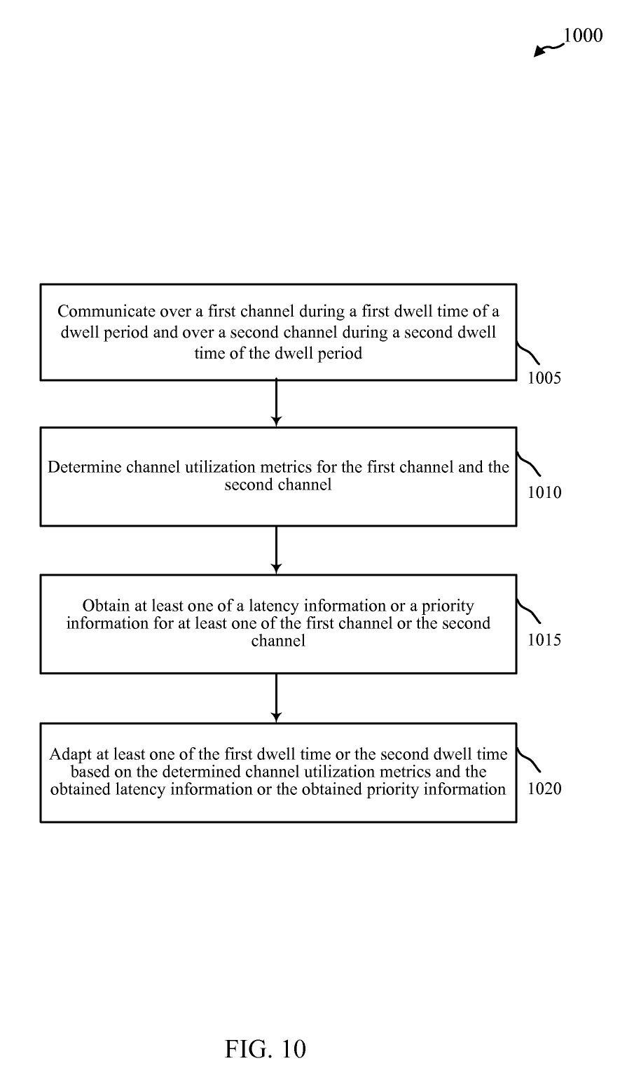

FIG. 10 is a flow chart illustrating one example of another method 1000 for dynamically scheduling channel time allocations across two or more channels utilized by a single radio in accordance with various embodiments. For clarity, the method 1000 is described below with reference to one or more aspects of one of the devices 110 described with reference to FIGS. 1 and/or 2, device 500-c described in reference to FIG. 5C, and/or device 600 described in reference to FIG. 6. In some embodiments, a device such as one of the devices 110 may execute one or more sets of codes to control the functional elements of the device 110 to perform the functions described below.

At block 1005, a device, such as device 110 of FIGS. 1 and/or 2, device 500-c of FIG. 5C, or device 600 of FIG. 6 may communicate over a first channel during a first dwell time of a dwell period and over a second channel during a second dwell time of the dwell period.

At block 1010, the device may determine channel utilization metrics for the first channel and the second channel.

At block 1015, the device may obtain at least one of a latency information or a priority information for at least one of the first channel or the second channel.

At block 1020, the device may adapt at least one of the first dwell time or the second dwell time based on the determined channel utilization metrics and the obtained latency information or the obtained priority information.

In some embodiments, method 1000 may be performed by any of devices 500-c or 600 as described above in reference to FIGS. 5C and 6. For example, the receiver 505 and transmitter 520, or the transceiver 610 and antennas 605 may in conjunction with the latency/priority information manager 525 obtain latency and/or priority information for at least one of the first or second channels. The channel utilization manager 510 may in conjunction with the receiver 505 and transmitter 520, or the transceiver 610 and antennas 605 determine channel utilization metrics for the first and second channel. The dwell time adaptor 515 may then in conjunction with the receiver 505 and transmitter 520 or the transceiver 610 and antennas 605 adapt at least one of the first dwell time or the second dwell time based on the obtained latency and/or priority information and on the determined channel utilization metrics.

Thus, the method 1000 may provide for dynamically scheduling channel time allocations across two or more channels utilized by a single radio. It should be noted that the method 1000 is just one implementation and that the operations of the method 1000 may be rearranged or otherwise modified such that other implementations are possible. One or more aspects of the method 700, 800, 900, and/or 1000 may in some cases be omitted or combined.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description, however, describes an LTE system for purposes of example, and LTE terminology is used in much of the description, although the techniques are applicable beyond LTE applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method, comprising:
using information regarding communications over a first channel during a first dwell time of a dwell period and over a second channel during a second dwell time of the dwell period to determine channel utilization metrics for the first channel and the second channel; and
adapting at least one of the first dwell time and the second dwell time based at least in part on the determined channel utilization metrics.

2. The method of claim 1, wherein adapting at least one of the first dwell time and the second dwell time comprises:
balancing channel utilization across the first channel and the second channel based at least in part on a comparison of the determined channel utilization metrics for the first and second channels.

3. The method of claim 1, wherein the channel utilization metrics for the first and second channels are based at least in part on ratios of transmitted and received traffic in sample time periods divided by channel capacities for the first and second channels.

4. The method of claim 3, wherein the channel capacities of the first and second channels are further based at least in part on at least one from the group consisting of a physical link speed of the respective channel, a proportion of time the respective channel is available to transmit, a medium access control (MAC) layer protocol efficiency of the respective channel, a transport layer protocol efficiency of the respective channel, and a combination thereof.

5. The method of claim 3, wherein the channel utilization metrics for the first and second channels are further based at least in part on an aggregate of calculated utilization metrics over multiple sample time periods.

6. The method of claim 1, further comprising:
adjusting the first dwell time and the second dwell time to a first and a second default dwell time responsive to a reset condition, the reset condition comprising at least one from the group consisting of a change in the channel utilization metrics for the first or second channels over a sample period being greater than a predetermined change threshold, a noise level on the first or second channels exceeding a predetermined noise threshold, a change in noise level for the first or second channels exceeding a predetermined noise change threshold, the channel utilization metrics for the first or second channels exceeding a first predetermined threshold, and the channel utilization metrics for the first and second channels being less than a second predetermined threshold.

7. The method of claim 6, wherein the first default dwell time equals the second default dwell time.

8. The method of claim 1, wherein adapting at least one of the first dwell time and the second dwell time further comprises adjusting at least one of the first dwell time and the second dwell time an amount proportionate to a determined difference between the channel utilization metrics for the first channel and the second channel.

9. The method of claim 1, wherein the first dwell time and the second dwell time are prevented from being adjusted above a predetermined maximum dwell time.

10. The method of claim 9, wherein the predetermined maximum dwell time for the first and second channels is based at least in part on a ratio between the first dwell time and the second dwell time.

11. The method of claim 1, wherein communicating over the first and second channels is performed by a single transceiver.

12. The method of claim 1, wherein the first channel and the second channel are in different Wi-Fi bands.

13. The method of claim 1, wherein the first channel comprises a Wi-Fi communication link with an access point (AP), and the second channel comprises a Wi-Fi-Direct communication link.

14. An apparatus for dynamically scheduling channel dwell times in a wireless communications network, comprising:
a channel utilization manager that determines channel utilization metrics for a first channel and a second channel using information regarding communications over the first channel during a first dwell time of a dwell period and over the second channel during a second dwell time of the dwell period; and
a dwell time adaptor that adapts at least one of the first dwell time and the second dwell time based at least in part on the determined channel utilization metrics.

15. The apparatus of claim 14, wherein the channel utilization manager balances channel utilization across the first channel and the second channel based at least in part on a comparison of the determined channel utilization metrics for the first and second channels.

16. The apparatus of claim 14, wherein the channel utilization metrics for the first and second channels are based at least in part on ratios of transmitted and received traffic in sample time periods divided by channel capacities for the first and second channels.

17. The apparatus of claim 16, wherein the channel capacities of the first and second channels are further based at least in part on at least one from the group consisting of a physical link speed of the respective channel, a proportion of time the respective channel is available to transmit, a medium access control (MAC) layer protocol efficiency of the respective channel, and a transport layer protocol efficiency of the respective channel.

18. The apparatus of claim 16, wherein the channel utilization metrics for the first and second channels are further based at least in part on an aggregate of calculated utilization metrics over multiple sample time periods.

19. The apparatus of claim 14, further comprising:
a default dwell time adaptor that adjusts the first dwell time and the second dwell time to first and second default dwell times responsive to a reset condition, the reset condition comprising at least one the group consisting of a change in the channel utilization metrics for the first or second channels over a sample period being greater than a predetermined change threshold, a noise level on the first or second channels exceeding a predetermined noise threshold, a change in noise level for the first or second channels exceeding a predetermined noise change threshold, the channel utilization metrics for the first or second channels exceeding a first predetermined threshold, and the channel utilization metrics for the first and second channels being less than a second predetermined threshold.

20. The apparatus of claim 14, wherein the first dwell time and the second dwell time are prevented from being adjusted above a predetermined maximum dwell time.

21. An apparatus for dynamically scheduling channel dwell times in a wireless communications network, comprising:
means for using information regarding communications over a first channel during a first dwell time of a dwell period and over a second channel during a second dwell time of the dwell period to determine channel utilization metrics for the first channel and the second channel; and
means for adapting at least one of the first dwell time and the second dwell time based at least in part on the determined channel utilization metrics.

22. The apparatus of claim 21, wherein the means for adapting at least one of the first dwell time and the second dwell balances channel utilization across the first channel and the second channel based at least in part on a comparison of the determined channel utilization metrics for the first and second channels.

23. The apparatus of claim 21, wherein the channel utilization metrics for the first and second channels are based at least in part on ratios of transmitted and received traffic in sample time periods divided by channel capacities for the first and second channels.

24. The apparatus of claim 23, wherein the channel capacities of the first and second channels are further based at least in part on at least one from the group consisting of a physical link speed of the respective channel, a proportion of time the respective channel is available to transmit, a medium access control (MAC) layer protocol efficiency of the respective channel, and a transport layer protocol efficiency of the respective channel.

25. The apparatus of claim 23, wherein the channel utilization metrics for the first and second channels are further based at least in part on an aggregate of calculated utilization metrics over multiple sample time periods.

26. The apparatus of claim 21, further comprising:
means for adjusting the first dwell time and the second dwell time to a first and a second default dwell time responsive to a reset condition, the reset condition comprising at least one from the group consisting of a change in the channel utilization metrics for the first or second channels over a sample period being greater than a predetermined change threshold, a noise level on the first or second channels exceeding a predetermined noise threshold, a change in noise level for the first or second channels exceeding a predetermined noise change threshold, the channel utilization metrics for the first or second channels exceeding a first predetermined threshold, and the channel utilization metrics for the first and second channels being less than a second predetermined threshold.

27. The apparatus of claim 21, wherein the means for adapting at least one of the first dwell time and the second dwell time adjusts at least one of the first dwell time and the second dwell time an amount proportionate to a determined difference between the channel utilization metrics for the first channel and the second channel.

28. A method, comprising:
obtaining at least one of a latency information and a priority information for at least one of a first channel and a second channel; and
adapting, using information regarding communications over the first channel during a first dwell time of a dwell period and over the second channel during a second dwell time of the dwell period, at least one of the first dwell time and the second dwell time based at least in part on at least one of the obtained latency information and the obtained priority information.

29. The method of claim 28, further comprising:
determining channel utilization metrics for the first channel and the second channel, wherein adapting at least one of the first dwell time and the second dwell time is based at least in part on the determined channel utilization metrics.

30. The method of claim 28, wherein adapting at least one of the first dwell time and the second dwell time further comprises setting at least one of an upper dwell time limit and a lower dwell time limit for at least one of the first channel and the second channel based at least in part on at least one of the obtained latency information and the obtained priority information.

31. The method of claim 28, wherein the priority information comprises at least one of a first priority comprising a maximum delay value and a second priority comprising a minimum throughput value.

32. The method of claim 28, wherein at least one of the obtained latency information and the obtained priority information relates to a traffic type of a traffic session associated with the at least one of the first channel and the second channel.

33. An apparatus for dynamically scheduling channel dwell times in a wireless communications network, comprising:
a latency priority information manager that obtains at least one of a latency information and a priority information for at least one of a first channel and a second channel; and
a dwell time adaptor that adapts, using information regarding communications over the first channel during a first dwell time of a dwell period and over the second channel during a second dwell time of the dwell period, at least one of the first dwell time and the second dwell time based at least in part on at least one of the obtained latency information and the obtained priority information.

34. The apparatus of claim 33, further comprising:
a channel utilization manager that determines channel utilization metrics for the first channel and the second channel, wherein adapting at least one of the first dwell time and the second dwell time is based at least in part on the determined channel utilization metrics.

35. The apparatus of claim 33, wherein the dwell time adaptor sets at least one of an upper dwell time limit and a lower dwell time limit for at least one of the first channel and the second channel based at least in part on at least one of the obtained latency information and the obtained priority information.

36. The apparatus of claim 33, wherein the priority information comprises at least one of a first priority comprising a maximum delay value and a second priority comprising a minimum throughput value.

37. The apparatus of claim 33, wherein at least one of the obtained latency information and the obtained priority information relates to a traffic type of a traffic session associated with the at least one of the first channel and the second channel.

38. An apparatus for dynamically scheduling channel dwell times in a wireless communications network, comprising:
means for obtaining at least one of a latency information and a priority information for at least one of a first channel and a second channel; and
means for adapting, using information regarding communications over the first channel during a first dwell time of a dwell period and over the second channel during a second dwell time of the dwell period, at least one of the first dwell time and the second dwell time based at least in part on at least one of the obtained latency information and the obtained priority information.

39. The apparatus of claim 38, further comprising:
means for determining channel utilization metrics for the first channel and the second channel, wherein adapting at least one of the first dwell time and the second dwell time is based at least in part on the determined channel utilization metrics.

40. The apparatus of claim 38, wherein the means for adapting at least one of the first dwell time and the second dwell time sets at least one of an upper dwell time limit and a lower dwell time limit for at least one of the first channel and the second channel based at least in part on at least one of the obtained latency information and the obtained priority information.

41. A computer program product comprising a non-transitory computer-readable medium storing instructions executable by a processor to:
determine channel utilization metrics for a first channel and a second channel using information regarding communications over the first channel during a first dwell time of a dwell period and over the second channel during a second dwell time of the dwell period;
obtain at least one of a latency information and a priority information for at least one of the first channel and the second channel; and
adapt at least one of the first dwell time and the second dwell time based at least in part on at least one of the determined channel utilization metrics and the obtained at least one of the latency information and the priority information.

42. The computer program product of claim 41, wherein non-transitory computer-readable medium further stores instructions executable by the processor to:
balance channel utilization across the first channel and the second channel based at least in part on a comparison of the determined channel utilization metrics for the first and second channels.

43. The computer program product of claim 41, wherein non-transitory computer-readable medium further stores instructions executable by the processor to:
set at least one of an upper dwell time limit and a lower dwell time limit for at least one of the first channel and the second channel based at least in part on at least one of the obtained latency information and the obtained priority information.

44. The computer program product of claim 41, wherein the channel utilization metrics for the first and second channels are based at least in part on ratios of transmitted and received traffic in sample time periods divided by channel capacities for the first and second channels.

45. The computer program product of claim 44, wherein the channel capacities of the first and second channels are further based at least in part on at least one from the group consisting of a physical link speed of the respective channel, a proportion of time the respective channel is available to transmit, a medium access control (MAC) layer protocol efficiency of the respective channel, a transport layer protocol efficiency of the respective channel, and a combination thereof.
